(19) United States
(12) Patent Application Publication
(10) Pub. No.: US 2009/0217801 A1
(43) Pub. Date: Sep. 3, 2009

(54) Foldable saxophone stand

(75) Inventor: Wu-Hong Hsieh, Lu Chou City (TW)

Correspondence Address: CHARLES E. BAXLEY, ESQUIRE, 90 JOHN STREET, SUITE 309, NEW YORK, NY, 10038, US

(73) Assignee: K.H.S. Musical Instrument Co., Ltd.

(21) Appl. No.: 12/072,799

(22) Filed: Feb. 28, 2008

(51) Int. Cl. G10D 9/00

(52) U.S. Cl. 84/385 A; 84/385 P

(57) ABSTRACT

A foldable saxophone stand has a base, multiple feet, a support, a lower bracket and an upper bracket. The feet and the support are mounted pivotally on the base. The lower bracket and the upper bracket are mounted pivotally on the support. Therefore, the feet, the support, the upper and lower bracket can be folded or unfolded easily and no elements of the foldable saxophone stand should be removed.

### BACKGROUND OF THE INVENTION

1. Field of the Invention

The present invention relates to a foldable saxophone stand, especially to a saxophone stand that is be folded easily without taking apart and is taken along conveniently.

2. Description of the Prior Arts

With reference to FIG. 9, a conventional saxophone stand (70) has a base (71), three feet (72), a support (73), a lower bracket (74) and an upper bracket (75). The base (71) has a lower surface and an upper surface. The feet (72) are mounted on the lower surface of the base (71) to support the base (71) away from the ground. The support (73) is mounted on and protrudes out from the upper surface of the base (71). The lower bracket (74) and the upper bracket (75) are mounted respectively on the support (73).

A saxophone is put on the conventional saxophone stand (70) with a bell of the saxophone being mounted in the upper bracket (75) and a bow of the saxophone being mounted on the lower bracket (74) and abutting the support (73). However, the conventional saxophone stand (70) can not be folded and occupy a lot of room while unused.

With further reference to FIG. 10, another conventional foldable saxophone stand (80) has a base (81), a rear foot (82), two front feet (83), two supporting rods (84), two supports (85), a bolt (86) and a bracket (87). The base (81) has a front surface, a rear surface and four recesses (811). The recesses (811) are formed respectively and radially on the front surface of the base (81) and communicate with each other. The rear foot (82) is mounted through the base (81) on the rear surface. The front feet (83) are mounted respectively in two adjacent recesses (811) of the base (81) and each front foot (83) has a proximal end. The front and rear feet (83, 82) support the base (81) away from the ground. The supporting rods (84) are mounted on the front surface of the base (81). The supports (85) are mounted respectively in the other two adjacent recesses (811) of the base (81) and each support (85) has a proximal end. The bolt (86) is mounted in the front surface of the base (81), connects to the rear foot (82) and abuts the proximal ends of the front feet (83) and the supports (85) to hold the front feet (83) and the supports (85) securely in the base (81). The bracket (87) is mounted between the supports (85).

A saxophone is mounted on the conventional foldable saxophone stand (80) with a body of the saxophone leaning against the bracket (87) and a bow of the saxophone being mounted on the supporting rods (84). Though the conventional foldable saxophone stand (80) can be folded to be taken along, the bolt (86) should be removed from the base (81) and the rear foot (82) in order to fold or unfold the rear foot (82), the front feet (83) and the supports (85). Therefore, the bolt (86) has chances of missing and the conventional foldable saxophone stand (80) might never be used again. Furthermore, the supports (85) can not be too long in case the conventional foldable saxophone stand (80) is not balance and falls. Consequently, when the saxophone is placed on the conventional foldable saxophone stand (80), the short supports (85) and the bracket (87) can not hold the saxophone stably. The saxophone and the conventional foldable saxophone stand (80) might fall easily eventually.

Besides, sizes of the conventional saxophone stands (70, 80), especially sizes of the supports (73, 85), are fixed. Therefore, different kinds of saxophones (alto or tenor) can not use the same conventional saxophone stands (70, 80). The conventional saxophone stands (70, 80) should be manufactured and bought respectively for different kinds or sizes of saxophones.

To overcome the shortcomings, the present invention provides a foldable saxophone stand to mitigate or obviate the aforementioned problems.

### SUMMARY OF THE INVENTION

The main objective of the present invention is to provide a foldable saxophone stand that has a base, multiple feet, a support, a lower bracket and an upper bracket. The feet and the support are mounted pivotally on the base. The lower bracket and the upper bracket are mounted pivotally on the support.

Therefore, the feet, the support, the upper and lower bracket can be folded or unfolded easily and no elements of the foldable saxophone stand should be removed.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a foldable saxophone stand in accordance with the present invention;

FIG. 2 is a side view of the foldable saxophone stand in FIG. 1;

FIG. 3 is an operational side view of the foldable saxophone stand in FIG. 1, shown an upper bracket and a lower bracket being folded;

FIG. 4 is an operational side view of the foldable saxophone stand in FIG. 1, shown a positioning pin being out of the positioning recess;

FIG. 5 is an operational side view of the foldable saxophone stand in FIG. 1, shown a support being folded;

FIG. 6 is an operational side view of the foldable saxophone stand in FIG. 1, shown fully folded;

FIG. 7 is an enlarged cross-sectional side view of a base of the foldable saxophone stand in FIG. 1;

FIG. 8 is an enlarged cross-sectional side view of an arm of the foldable saxophone stand in FIG. 1;

FIG. 9 is a perspective view of a conventional saxophone stand in accordance with the prior art; and

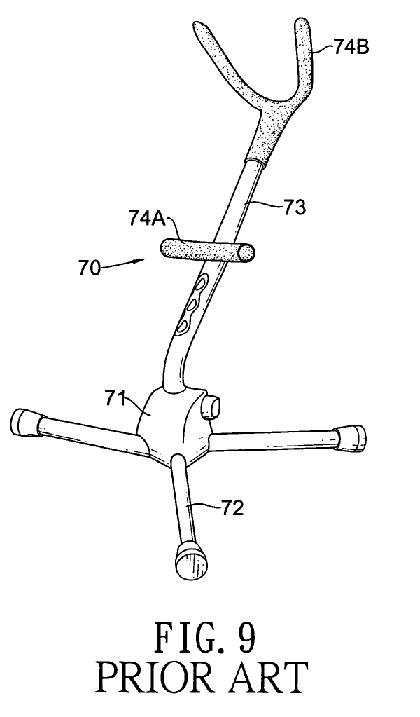

FIG. 10 is a perspective view of another conventional foldable saxophone stand in accordance with the prior art.

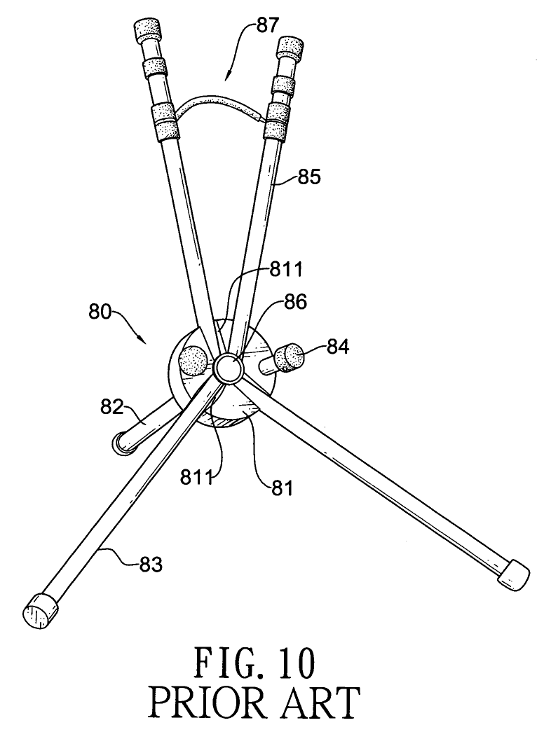

### DETAILED DESCRIPTION OF THE PREFERRED EMBODIMENTS

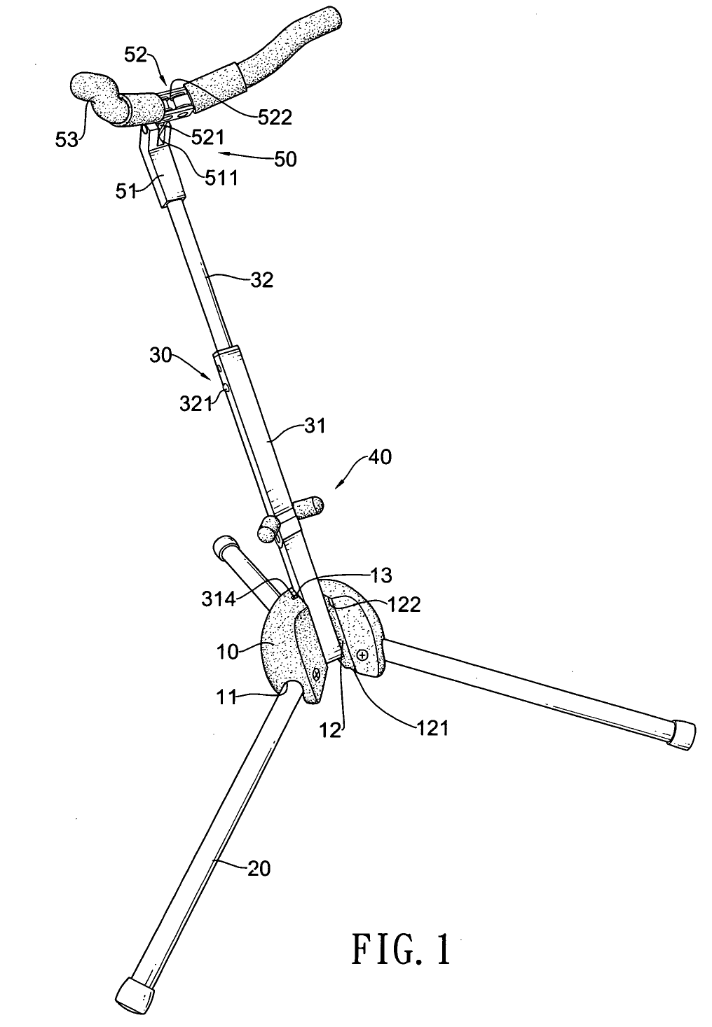

With reference to FIG. 1, a foldable saxophone stand in accordance with the present invention comprises a base (10), multiple feet (20), a support (30), a lower bracket (40) and an upper bracket (50).

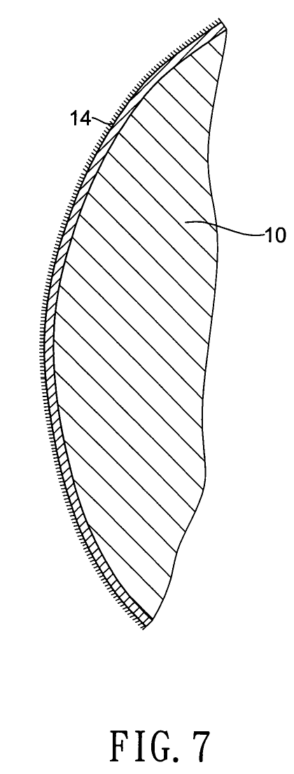

With further reference to FIG. 7, the base (1O) may be covered with pads (14) and has a side surface, a lower surface, an upper surface, multiple foot recesses (11), a support recess (12) and two positioning recesses (13).

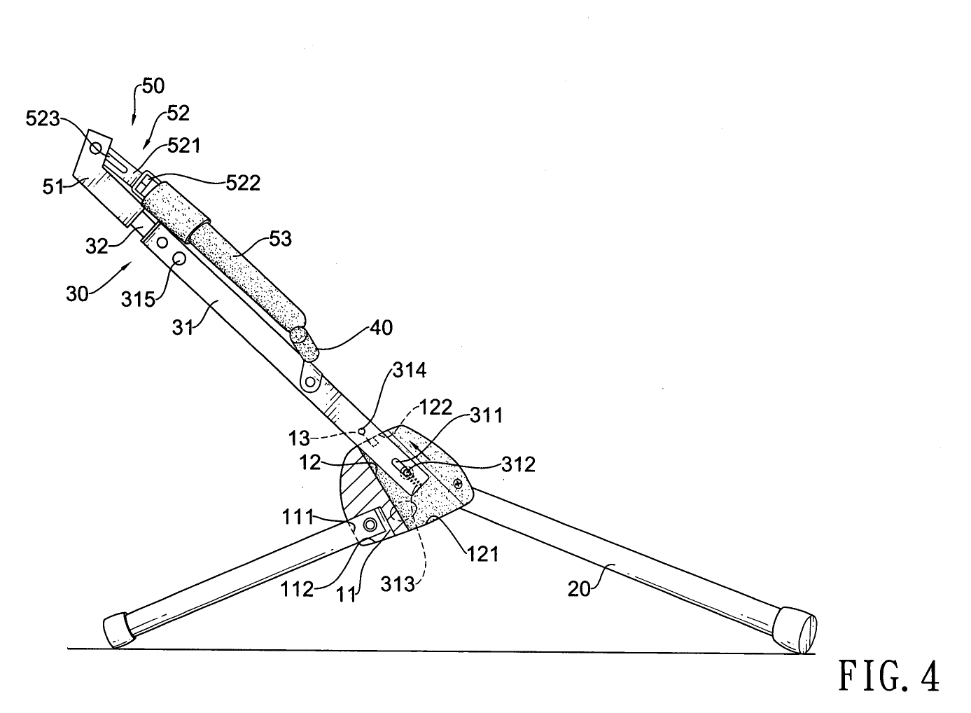

With further reference to FIG. 4, the foot recesses (11) are formed respectively in the side and lower surfaces of the base (10). Each foot recess (11) has an unfolded end (111) and a folded end (112) and a linkage. The unfolded end (111) is formed in the side surface of the base (10) and has a width. The folded end (112) is formed in the lower surface of the base (10) and has a width. The linkage is formed between the unfolded and folded ends (111, 112) of the foot recess (11) and has a width. The width of the linkage may be smaller than the width of the unfolded end (111) and the width of the folded end (112) of the foot recess (11).

The support recess (12) is formed respectively in the side, lower and upper surfaces of the base (10) and has a folded end (121) and an unfolded end (122). The folded end (121) is formed in the lower surface of the base (10). The unfolded end (122) is formed in the upper surface of the base (10).

The positioning recesses (13) are formed respectively and oppositely in the upper surface of the base (10) and communicate with the support recess (12) adjacent to the unfolded end (122) of the support recess (12).

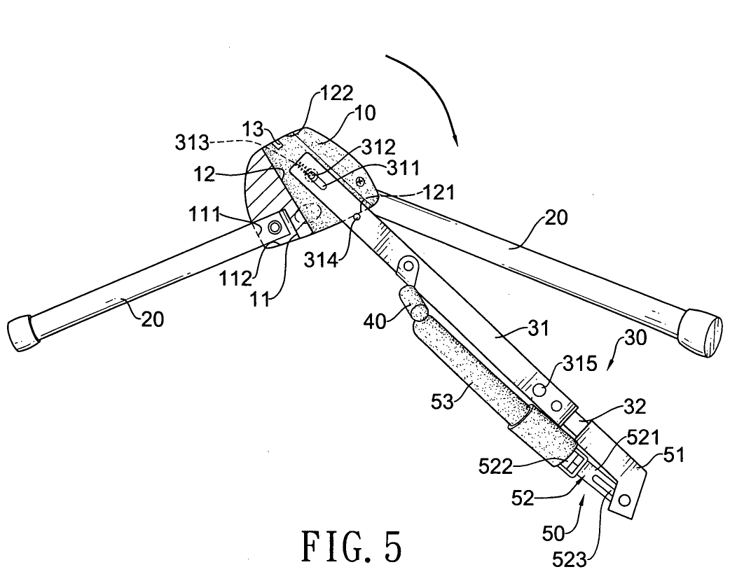

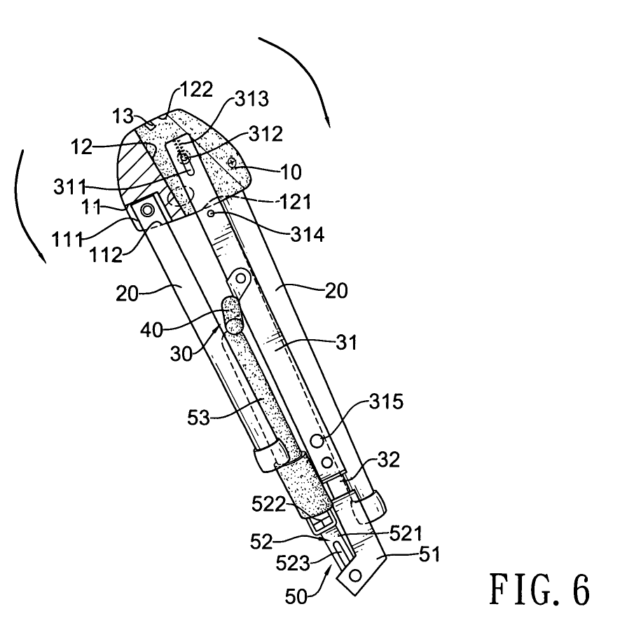

With further reference to FIGS. 5 and 6, the feet (20) are mounted respectively and pivotally in the foot recesses (11) of the base (10), are mounted selectively through the folded ends (112) of the foot recesses (11) to fold the feet (20) and are mounted selectively through the unfolded ends (111) of the foot recesses (11) to unfold the feet (20).

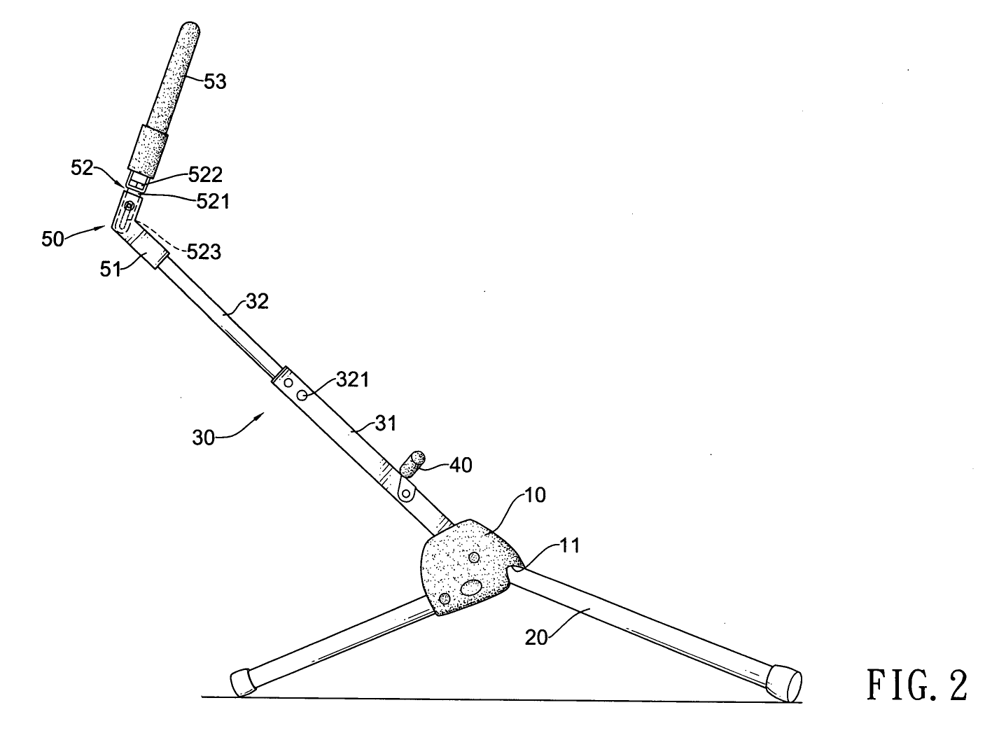

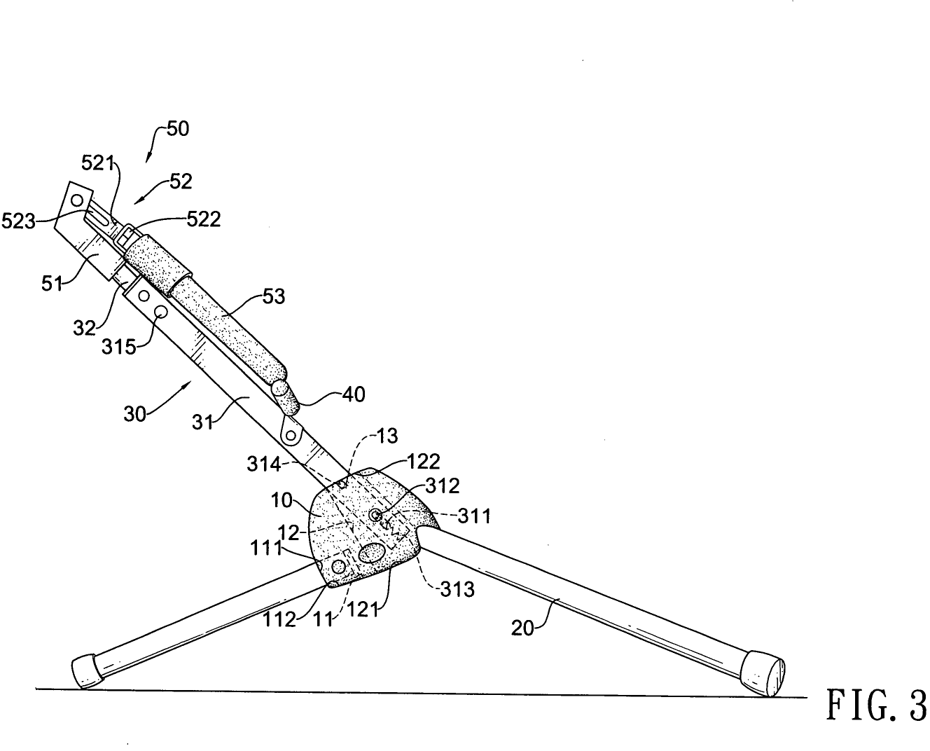

With further reference to FIGS. 2 and 3, the support (30) is tubular, is mounted pivotally in the support recess (12) of the base (10) and has a proximal end, a distal end, a proximal tube (31), a distal tube (32), a slot (311), a pivot pin (312), a spring (313), a positioning pin (314), multiple lock hole (315) and a lock pin (321).

The proximal tube (31) is mounted pivotally in the support recess (12) of the base (10) and has a proximal end and a distal end.

The distal tube (32) is mounted movably in the distal end of the proximal tube (31) to selectively retract the support (30) and has a distal end.

The slot (311) is formed through the support (30) near the proximal end of the support (30) and may be formed through the proximal tube (31) near the proximal end of the proximal tube (31).

The pivot pin (312) is mounted through the slot (311) of the proximal tube (31) of the support (30) and is connected securely to the base (10).

The spring (313) is mounted in the support (30) near the proximal end of the support (30), is connected to the pivot pin (312) and the proximal end of the support (30), may be mounted in the proximal tube (31) near the proximal end of the proximal tube (31) and may be connected to the pivot pin (312) and the proximal end of the proximal tube (31).

The positioning pin (314) is mounted through and protrudes out of the support (30) near the slot (311), may be mounted through and protrudes out of the proximal tube (31) near the slot (311) and is selectively mounted in the positioning recesses (13) of the base (10) when the support (30) is unfolded.

The lock holes (315) are formed respectively through the proximal tube (31) of the support (30).

The lock pin (321) is mounted retractably in the distal tube (32) of the support (30) near the proximal end of the distal tube (32) and is selectively engaging one of the lock holes (315) of the proximal tube (31) of the support (30) when the tubes (31, 32) of support (30) is stretched outwardly.

The lower bracket (40) is mounted pivotally on the support (30) and may be mounted pivotally on the proximal tube (31). When the lower bracket (40) is unfolded, the lower bracket (40) is mounted transversely on the support (30).When the lower bracket (40) is folded, the lower bracket (40) is mounted longitudinally on the support (30).

The upper bracket (50) is mounted on the distal end of the support (30), may be mounted on the distal end of the distal tube (32) and has a connecting tube (51), a pivot bracket (52) and two arms (53).

The connecting tube (51) is curved, is mounted on the distal end of the support (30), may be mounted on the distal end of the distal tube (32) and has a distal end and a pivot recess (511). The pivot recess (511) is formed in the distal end of the connecting tube (51).

The pivot bracket (52) is mounted pivotally in the distal end of the support (30), may be mounted pivotally in the distal end of distal tube (32), may be mounted pivotally in the distal end of the connecting tube (51) and may have a pivot connector (521), an arm mount (522) and a slot (523). The pivot connector (521) is mounted pivotally in the pivot recess (511) of the connecting tube (51) and has an outer end. The arm mount (522) is formed on the outer end of the pivot connector (521). The slot (523) is formed through the pivot connector (521). Therefore, the pivot bracket (52) may selectively move along the slot (523) to be mounted into the connecting tube (51) to unfold the pivot bracket (52), and may selectively be pulled out of the connecting tube (51) along the slot (523) and then pivot to fold the pivot bracket (52).

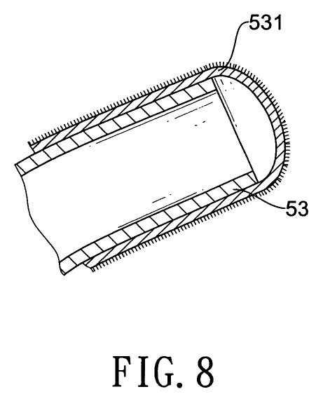

With further reference to FIG. 8, the arms (53) may be covered with pads (531), are mounted respectively and pivotally in the pivot bracket (52) and may be mounted respectively and pivotally in the arm mount (522) of the pivot bracket (52).

The foldable saxophone stand as described as the following advantages. When the foldable saxophone stand as described is unfolded, a saxophone may be put on the foldable saxophone stand with a body of the saxophone being mounted in the upper bracket (50) and a bow of the saxophone being mounted on the lower bracket (40). Furthermore, since the proximal tube (31) and the distal tube (32) are retractable, length of the support (30) may be adjusted easily to correspond to different kinds and sizes of saxophones.

When the foldable saxophone stand as described is folded, no elements should be removed and the folded foldable saxophone stand may be stored in a saxophone box for the convenience to be taken along. Furthermore, since the base (10) and the arms (53) of the upper bracket (50) are covered with pads (14, 531), the foldable saxophone stand as described may further be stored in bell of the saxophone and would not scratch the saxophone.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A foldable saxophone stand comprising
a base having
a side surface;
a lower surface;
an upper surface;
multiple foot recesses being formed respectively in the side and lower surfaces of the base and each foot recess having
an unfolded end being formed in the side surface of the base and having a width;
a folded end being formed in the lower surface of the base and having a width; and
a linkage being formed between the unfolded and folded ends of the foot recess and having a width; and
a support recess being formed respectively in the side, lower and upper surfaces of the base and having
a folded end being formed in the lower surface of the base; and
an unfolded end being formed in the upper surface of the base;
multiple feet being mounted respectively and pivotally in the foot recesses of the base;
a support being tubular, being mounted pivotally in the support recess of the base and having
a proximal end;
a distal end;
a slot being formed through the support near the proximal end of the support; and
a pivot pin being mounted through the slot of the support and being connected securely to the base;
a lower bracket being mounted pivotally on the support; and
an upper bracket being mounted on the distal end of the support and having
a pivot bracket being mounted pivotally in the distal end of the support; and
two arms being mounted respectively and pivotally in the pivot bracket.

2. The foldable saxophone stand as claimed in claim 1, wherein the support further has a spring being mounted in the support near the proximal end of the support and being connected to the pivot pin and the proximal end of the support.

3. The foldable saxophone stand as claimed in claim 2, wherein
the base further has two positioning recesses being formed respectively and oppositely in the upper surface of the base and communicating with the support recess adjacent to the unfolded end of the support recess; and
the support further has a positioning pin being mounted through and protruding out of the support near the slot and being selectively mounted in the positioning recesses of the base.

4. The foldable saxophone stand as claimed in claim 1, wherein
the support further has
a proximal tube being mounted pivotally in the support recess of the base and having
a proximal end; and
a distal end; and
a distal tube being mounted movably in the distal end of the proximal tube and having a distal end;
the slot of the support is formed through the proximal tube near the proximal end of the proximal tube;
the spring of the support is mounted in the proximal tube near the proximal end of the proximal tube and is connected to the pivot pin and the proximal end of the proximal tube;
the positioning pin of the support is mounted through and protrudes out of the proximal tube near the slot;
the lower bracket is mounted pivotally on the proximal tube;
the upper bracket is mounted on the distal end of the distal tube; and
the pivot bracket of the upper bracket is mounted pivotally in the distal end of the distal tube.

5. The foldable saxophone stand as claimed in claim 2, wherein
the support further has
a proximal tube being mounted pivotally in the support recess of the base and having
a proximal end; and
a distal end; and
a distal tube being mounted movably in the distal end of the proximal tube and having a distal end;
the slot of the support is formed through the proximal tube near the proximal end of the proximal tube;
the spring of the support is mounted in the proximal tube near the proximal end of the proximal tube and is connected to the pivot pin and the proximal end of the proximal tube;
the positioning pin of the support is mounted through and protrudes out of the proximal tube near the slot;
the lower bracket is mounted pivotally on the proximal tube;
the upper bracket is-mounted on the distal end of the distal tube; and
the pivot bracket of the upper bracket is mounted pivotally in the distal end of the distal tube.

6. The foldable saxophone stand as claimed in claim 3, wherein
the support further has
a proximal tube being mounted pivotally in the support recess of the base and having
a proximal end; and
a distal end; and
a distal tube being mounted movably in the distal end of the proximal tube and having a distal end;
the slot of the support is formed through the proximal tube near the proximal end of the proximal tube;
the spring of the support is mounted in the proximal tube near the proximal end of the proximal tube and is connected to the pivot pin and the proximal end of the proximal tube;
the positioning pin of the support is mounted through and protrudes out of the proximal tube near the slot;
the lower bracket is mounted pivotally on the proximal tube;
the upper bracket is mounted on the distal end of the distal tube; and
the pivot bracket of the upper bracket is mounted pivotally in the distal end of the distal tube.

7. The foldable saxophone stand as claimed in claim 4, wherein
the upper bracket further has a curved connecting tube, being mounted on the distal end of the distal tube of the support and having
a distal end; and
a pivot recess being formed in the distal end of the connecting tube;
the pivot bracket of the upper bracket is mounted pivotally in the distal end of the connecting tube and has
a pivot connector being mounted pivotally in the pivot recess of the connecting tube and having an outer end;
an arm mount being formed on the outer end of the pivot connector; and
a slot being formed through the pivot connector; and
the arms of the upper bracket are mounted respectively and pivotally in the arm mount of the pivot bracket.

8. The foldable saxophone stand as claimed in claim 5, wherein
the upper bracket further has a curved connecting tube, being mounted on the distal end of the distal tube of the support and having
a distal end; and
a pivot recess being formed in the distal end of the connecting tube;
the pivot bracket of the upper bracket is mounted pivotally in the distal end of the connecting tube and has
a pivot connector being mounted pivotally in the pivot recess of the connecting tube and having an outer end;
an arm mount being formed on the outer end of the pivot connector; and
a slot being formed through the pivot connector; and
the arms of the upper bracket are mounted respectively and pivotally in the arm mount of the pivot bracket.

9. The foldable saxophone stand as claimed in claim 6, wherein
the upper bracket further has a curved connecting tube, being mounted on the distal end of the distal tube of the support and having
a distal end; and
a pivot recess being formed in the distal end of the connecting tube;
the pivot bracket of the upper bracket is mounted pivotally in the distal end of the connecting tube and has
a pivot connector being mounted pivotally in the pivot recess of the connecting tube and having an outer end;
an arm mount being formed on the outer end of the pivot connector; and
a slot being formed through the pivot connector; and
the arms of the upper bracket are mounted respectively and pivotally in the arm mount of the pivot bracket.

10. The foldable saxophone stand as claimed in claim 7, wherein the support further has
multiple lock holes being formed respectively through the proximal tube of the support; and
a lock pin being mounted retractably in the distal tube of the support near the proximal end of the distal tube and selectively engaging one of the lock holes of the proximal tube of the support.

11. The foldable saxophone stand as claimed in claim 8, wherein the support further has
multiple lock holes being formed respectively through the proximal tube of the support; and
a lock pin being mounted retractably in the distal tube of the support near the proximal end of the distal tube and selectively engaging one of the lock holes of the proximal tube of the support.

12. The foldable saxophone stand as claimed in claim 9, wherein the support further has
multiple lock holes being formed respectively through the proximal tube of the support; and
a lock pin being mounted retractably in the distal tube of the support near the proximal end of the distal tube and selectively engaging one of the lock holes of the proximal tube of the support.

13. The foldable saxophone stand as claimed in claim 10, wherein the width of the linkage of each foot recess is narrower than the width of the unfolded end and the width of the folded end of the foot recess.

14. The foldable saxophone stand as claimed in claim 11, wherein the width of the linkage of each foot recess is narrower than the width of the unfolded end and the width of the folded end of the foot recess.

15. The foldable saxophone stand as claimed in claim 12, wherein the width of the linkage of each foot recess is narrower than the width of the unfolded end and the width of the folded end of the foot recess.

16. The foldable saxophone stand as claimed in claim 13, wherein the base and the arms are covered with pads.

17. The foldable saxophone stand as claimed in claim 14, wherein the base and the arms are covered with pads.

18. The foldable saxophone stand as claimed in claim 15, wherein the base and the arms are covered with pads.
